(19) United States
(12) Patent Application Publication
(10) Pub. No.: US 2013/0138527 A1
(43) Pub. Date: May 30, 2013

(54) DYNAMIC CUSTOMER PURCHASE AUCTION EVENT

(71) Applicant: Robyn R. Schwartz, Chicago, IL (US)

(72) Inventor: Robyn R. Schwartz, Chicago, IL (US)

(73) Assignee: INTERNATIONAL BUSINESS MACHINES CORPORATION, Armonk, NY (US)

(21) Appl. No.: 13/307,307

(22) Filed: Nov. 30, 2011

(51) Int. Cl. G06Q 30/08

(52) U.S. Cl. 705/26.3

(57) ABSTRACT

A customer selects a first product in a retailer channel and scans the product at a POS device. The scan and product are sent to a plurality of suppliers in real time over a network. The suppliers send bids for a related product over the network in real time to the retailer who presents the bids to the customer. The customer purchases the related product thereby increasing sales of his product.

### BACKGROUND OF THE INVENTION

1. Field of the Invention

The invention relates to systems for increasing sales in a retail channel, such as in-store purchases by customers. More specifically, the invention makes use of techniques similar to a reverse auction to present bids from suppliers for products related to a product a customer has scanned in a retail channel.

2. Description of the Related Art

Catane in U.S. Pat. No. 7,996,298 describes a reverse auction system having aspects of customer anonymity and consolidation of bids using a network. Mulluins in WIPO application WO 2007/100797 describes systems for conducting and managing reverse auctions with open or sealed bidding, as well as, secured gaming or auctions within a private or virtual private network. Earlier, Hoffman et al in US Patent Publication US 2003/0069825 describe a system for a reverse auction in a supply chain in which the price decreases as a function of time during a predetermined duration.

### BRIEF SUMMARY OF THE INVENTION

A system, method, and program product offers a product to a potential customer. A customer scan of a first product in a retailer channel, such as a scan of a product to be purchased by a retail customer at a point-of-sale terminal in a retail store, is performed. In response, a notification of the scan and the product is sent over a network to a plurality of suppliers of a related product.

The retailer automatically receives bids over the network in real time from the suppliers. The bids are for immediate purchase of the related product by the customer via the same channel, e.g., the retail store, at a price. The retailer communicates the bid for the related product to the customer also in real time. The customer may thereupon decide to purchase the related product via the same retail channel in response to one of the price bids.

### BRIEF DESCRIPTION OF THE SEVERAL VIEWS OF THE DRAWINGS

FIG. 1 depicts an exemplary computer in which the present invention may be implemented;

FIG. 2 is a system block diagram for practicing the present invention; and

FIG. 3 is a flowchart of steps performed in carrying out the present invention.

### DETAILED DESCRIPTION OF THE INVENTION

For a better understanding of the present invention, together with other and further objects, advantages, and capabilities thereof, reference is made to the following disclosure and the appended claims in connection with the above-described drawings.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any Combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program Code embodied on a computer readable method may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on a computer, other programmable apparatus or other devices to produce a computer implemented process such that the instructions which execute on the computer or other programmable apparatus provide processes for implementing the functions/acts specified in the flowchart and/or block diagram block or blocks.

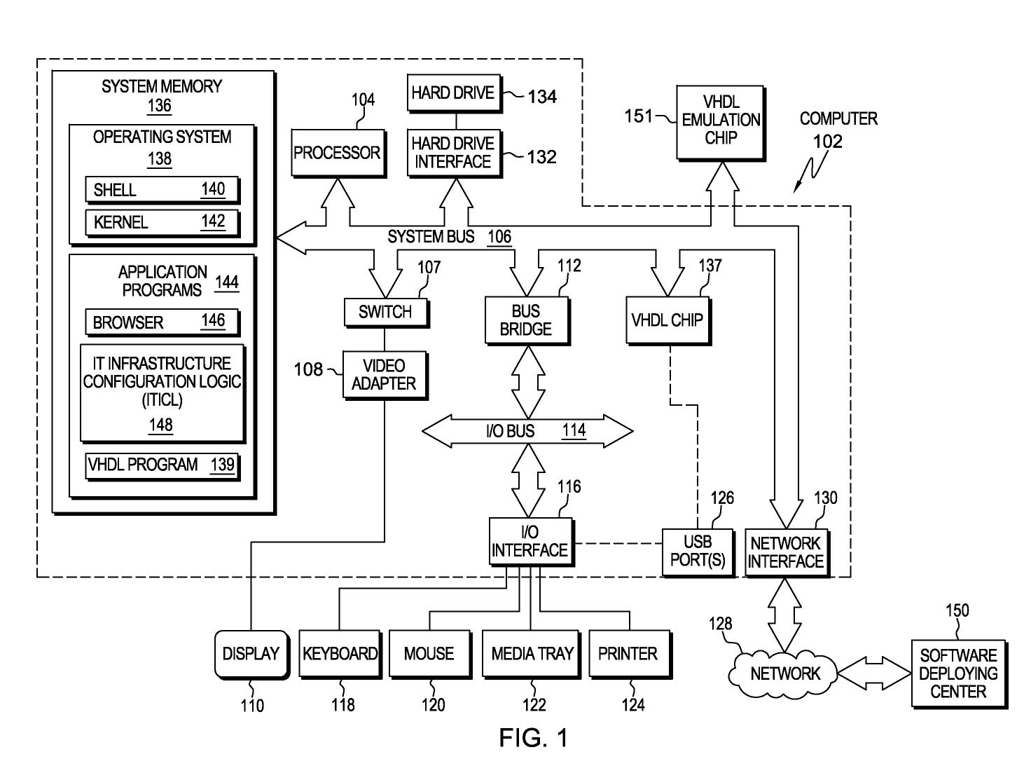

With reference now to the figures, and in particular to FIG. 1, there is depicted a block diagram of an exemplary computer 102, which may be utilized by the present invention. Note that some or all of the exemplary architecture, including both depicted hardware and software, shown for and within computer 102 may be utilized by software deploying server 150.

Computer 102 includes a processor 104 that is coupled to a system bus 106. Processor 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., information technology infrastructure configuring logic—ITICL 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, computer 102 is able to communicate with a software deploying server 150 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

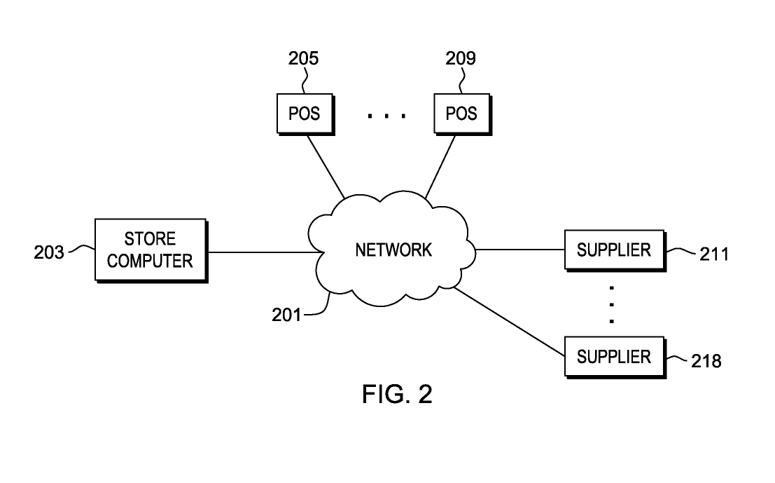

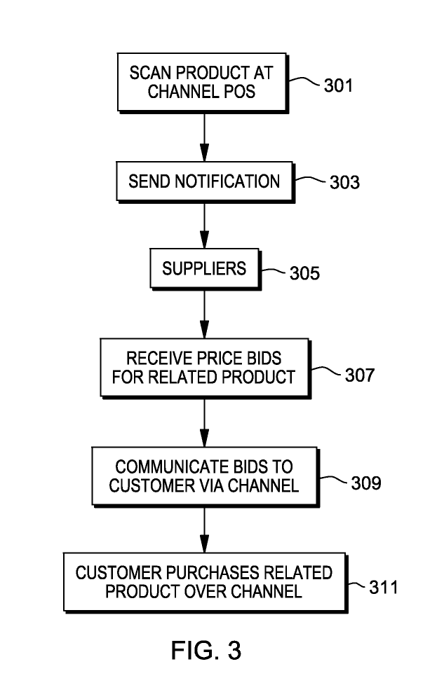

Application programs 144 in computer 102's system memory (as well as software deploying server 150's system memory) also include an information technology infrastructure configuring logic (ITICL) 148. ITICL 148 includes code for implementing the processes described below, including those described in FIGS. 2-3. In one embodiment, computer 102 is able to download ITICL 148 from software deploying server 150, including in an on-demand basis, wherein the code in ITICL 148 is not downloaded until needed for execution to define and/or implement the improved enterprise architecture described herein. Note further that, in one embodiment of the present invention, software deploying server 150 performs all of the functions associated with the present invention (including execution of ITICL 148), thus freeing computer 102 from having to use its own internal computing resources to execute ITICL 148.

There may also be stored in system memory 136 a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from ITICL 148 causes VHDL program 139 to configure VHDL chip 137 (if present), which may be an FPGA, ASIC, etc.

In another embodiment of the present invention, execution of instructions from ITICL 148 results in a utilization of VHDL program 139 to program a VHDL emulation chip 151. VHDL emulation chip 151 may incorporate a similar architecture as described above for VHDL chip 137. Once ITICL 148 and VHDL program 139 program VHDL emulation chip 151, VHDL emulation chip 151 performs, as hardware, some or all functions described by one or more executions of some or all of the instructions found in ITICL 148. That is, the VHDL emulation chip 151 is a hardware emulation of some or all of the software instructions found in ITICL 148. In one embodiment, VHDL emulation chip 151 is a programmable read only memory (PROM) that, once burned in accordance with instructions from ITICL 148 and VHDL program 139, is permanently transformed into a new circuitry that performs the functions needed to perform the process described below in FIGS. 2-3.

The hardware elements depicted in computer 102 are not intended to be exhaustive, but rather are representative to highlight essential components required by the present invention. For instance, computer 102 may include alternate memory storage devices, such as magnetic cassettes, digital versatile disks (DVDs), Bernoulli cartridges, and the like. These and other variations are intended to be within the spirit and scope of the present invention.

In FIG. 2, there is shown a system diagram for an embodiment of the present invention. Store computer 203 may be any type of computing device known in the art, including the computer 102 of FIG. 1. Store computer is attached to network 201, which may be any type of network, such as the Internet, a local area network, a wide area network, a wi-fi network, bluetooth, a dial-up network, or fiber network.

Point-of-sale (POS) devices 205-209 are also attached to network 201. POS devices may be bar code scanning apparatus, such as devices used in retail stores to check out customer purchases. POS devices may also be portable devices, including smart phones, palmtop or laptop devices programmed to be used for similar purposes, whether or not such devices are capable of reading bar codes from retail products. POS devices 205-209 may be operated by store personnel or by customers themselves. POS devices 205-209 are preferably located within a retail store, however, some POS devices may be located external to a store, but communicate with store computer 203 via network 201.

Store computer 203 may also communicate with a plurality of suppliers 211-218 via network 201. Suppliers 211-218 manufacture products sold in the retail store of the present invention. Suppliers typically have no visibility at the point of customer decision, that is, if the customer is interacting with their product through a retailer. Therefore, suppliers have no way to understand customer “switch or walk” decisions, that is how a customer makes a decision to switch to a new product or stick with another product or offering, or as to what factors drive a customer to purchase one product or another when they are interacting through a retailer across any channel. Suppliers 211-218 may be connected to network 201 using any type of device which attaches to the network including but not limited to a computer, a laptop or palmtop, or a smart phone.

In FIG. 3, there is shown a flowchart of steps performed in one embodiment of the present invention using a system, such as shown in FIG. 2. In step 301, a customer selects a first product. The customer may have selected the first product for purchase, or may still be considering the product and comparing it to others. The first product is scanned at a point-of-sale device in a retail channel, preferably a retail store.

Although the scan is normally sent over network 201 to store computer 203, in step 303, a notification of the scan and the product is immediately sent in real time to a plurality of suppliers 211-218 of a related product.

In step 305, the suppliers send bids for the related product in a manner having some similarities to a reverse auction. The bid may include more than just a price. The bid may include incentivized pricing strategies. For example, the bid may include a lower price for a given time or personalized to that customer. The bid may also include a “buy one get one” type offer or a “buy with” or “also get” type of promotion. The bid may include offers to be included in the current purchase or on the next trip. For example, a cookie may be placed on the customer's device to annotate the customer's acceptance of a next trip offer. A supplier is therefore in competition with other suppliers, and the retail store to earn the customer's purchase using either price based or promotion based incentives. The bids are received by the retail store computer in step 307.

In step 309, the bids for the related product are communicated to the customer in real time over the retail channel. The retailer may, for instance, have programmed his computer to present the bids in real time via the POS device to the customer. For example, the POS device may have a display screen visible to the customer. The POS device may have a printer which can be used to provide a printed listing of the bids in real time to the customer. Other technologies known in the art, e.g., text-to-speech may also be used.

In some embodiments, suppliers do not know what bids and corresponding prices are sent by other suppliers. Nor do the suppliers know the store price for the first product. In other embodiments, suppliers may be given visibility to some or all of this information. However, suppliers must send bids in real time to the retailer.

The retailer, in some embodiments, may chose to reject some bids by not communicating these to the customer. For example, the bid may not allow the retailer a sufficient product margin on the related product. However, the retailer may reject a bid for any legitimate reason.

In step 311, the customer purchases the selected product by selecting one of the bids over the retail channel.

Related product in step 307, may be a product which is complementary to the first product so that the customer in general buys both the first product and the related product thereby increasing sales for both the retailer and the supplier.

In other embodiments, the related product may be competitive with the first product. The supplier is then attempting to move the customer from purchasing the first product to purchasing his product, possibly by offering a lower price. The supplier thereby increases his sales, but the retailer may lose revenue. The supplier may compensate the retailer for this loss through a lower cost, rebate, or other compensation techniques.

While there have been shown and described what are at present considered the preferred embodiments of the invention, it will be obvious to those skilled in the art that various changes and modification may be made therein without departing from the scope of the invention as defined by the appended claims.

What is claimed is:

1. A method of offering a product to a potential customer, comprising the steps of:
in response to a customer scan of a first product in a retailer channel, sending notification of said scan and said product over a network in real time to a plurality of suppliers of a related product;
the retailer automatically receiving price bids over said network in real time from said plurality of suppliers for immediate purchase of said related product by said customer via said channel; and
the retailer communicating said bids for said related product to said customer in real time.

2. The method of claim 1, wherein said customer scan includes selection of said first product.

3. The method of claim 1, wherein said network has wireless connections.

4. The method of claim 1, wherein said retailer channel is a retail store.

5. The method of claim 4, wherein said customer is located in said retail store at the time said scan occurs.

6. The method of claim 1, further comprising the customer choosing to purchase said related product in response to one of said price bids.

7. A system for offering a product to a potential customer, comprising:
a network;
a plurality of point-of-sale devices connected to said network;
a computer connected to said network, said computer programmed to:
detect a scan for a customer at one of said point-of-sale devices for a first product and in response thereto, sending notification of said scan and said product over said network in real time to a plurality of suppliers of a related product;
automatically receive at said one of said point-of-sale devices, price bids over said network in real time from said plurality of suppliers for immediate purchase of said related product by said customer via said channel; and
communicate said bids for said related product to said customer in real time.

8. The system of claim 7, wherein said customer scan includes purchase of said first product by said customer.

9. The system of claim 7, wherein said point-of-sale device is a kiosk, a personal portable device, a laptop, or a personal computer.

10. The system of claim 7, wherein said retailer channel is a retail store.

11. The system of claim 10, wherein said customer is located in said retail store at the time said scan occurs.

12. The system of claim 7, wherein said one of said point-of-sale devices is programmed to allow the customer to choose to purchase said related product in response to one of said price bids.

13. A computer program product for instructing a processor to offer a product to a customer, said computer program product comprising:
a computer readable storage medium;
first program instruction means for in response to a customer scan of a first product in a retailer channel, sending notification of said scan and said product over a network in real time to a plurality of suppliers of a related product;
second program instruction means for the retailer automatically receiving price bids over said network in real time from said plurality of suppliers for immediate purchase of said related product by said customer via said channel; and
third program instruction means for the retailer communicating said bids for said related product to said customer in real time; and wherein
all said program instruction means are recorded on said medium.

14. The computer program product of claim 13, wherein said customer scan includes selection of said first product.

15. The computer program product of claim 13, wherein said network has wireless connections.

16. The computer program product of claim 13, wherein said retailer channel is a retail store.

17. The computer program product of claim 16, wherein said customer is located in said retail store at the time said scan occurs.

18. The computer program product of claim 13, further comprising fourth program instruction means for the customer choosing to purchase said related product in response to one of said price bids.
